(19) United States
(12) Patent Application Publication
(10) Pub. No.: US 2004/0175537 A1
(43) Pub. Date: Sep. 9, 2004

(54) Polymer component, apparatus and method

(76) Inventors: Kurt Schwarzwalder, Macomb, MI (US); Matthew P. Macker, Almont, MI (US); Craig Warren McGinnis, Pontiac, MI (US); Jeffrey Lee Hanna, Sterling Heights, MI (US)

Correspondence Address: DYKEMA GOSSETT PLLC, 39577 WOODWARD AVENUE, SUITE 300, BLOOMFIELD HILLS, MI, 48304, US

(21) Appl. No.: 10/804,650

(22) Filed: Mar. 19, 2004

Related U.S. Application Data
(62) Division of application No. 10/090,683, filed on Mar. 4, 2002.

(51) Int. Cl. B29C 41/24

(52) U.S. Cl. 428/100; 428/182; 264/167

(57) ABSTRACT

A process and apparatus utilize an extrusion and zone molding process in which a polymeric material is extruded, shaped and cooled to form a primary extrusion having a shaped length of uniform cross section, zone heating is then applied to only a portion of the primary extrusion creating a molten zone in that portion, the molten zone is aligned with a section mold to mold only that portion of the primary extrusion. The portion section molded cools quickly forming a section molded portion. Although an exemplary polymeric component is described herein, a variety of components may be produced utilizing the apparatus and method described by varying the shape of either the primary extrusion component or the section molded component, or both.

### FIELD OF INVENTION

This invention relates generally to a process and apparatus for forming a component including thermoplastic material, and the component produced thereby. More specifically, the process and apparatus utilize an extrusion process and zone molding process in which an extrusion is formed and prepared for subsequent section molding of only a portion of the extrusion.

### BACKGROUND

Forming components out of polymer materials may be accomplished by any one of a number of distinct forming techniques such as compression molding, blow molding, injection molding, extrusion molding, and casting.

Compression molding typically involves placement of a specified amount of solid polymer into a heated mold. The heat of the mold surface melts the polymer causing the material to become viscous and conform to the mold shape. Thermoplastic polymers typically require that pressure must be maintained as the piece is cooled so the formed article will retain its shape. The article must be sufficiently cooled before it is dimensionally stable enough to be removed from the mold, affecting production time of the article. This can be a significant disadvantage in high volume production of thermoplastic components.

Injection molding is among the more widely used techniques for fabricating thermoplastic components. Molten plastic is impelled through a nozzle into an enclosed mold cavity where cooling begins to take place almost immediately. Pressure is maintained until the plastic has solidified. The mold is opened and the piece is ejected. Solidification of thermoplastic parts is faster with this method providing, relatively short cycle times.

Extrusion of plastic material takes place as molten polymer is forced through at least one die orifice. To solidify the molten polymer blowers, water spray or submersion may be provided. A calibrator may also be used to shape the extrusion. The calibrator may be in the shape of a short or long tube or a series of disk shaped dies with an orifice, through which the extrusion passes, forming the profile to its final shape. Extrusion molding is well suited to production of continuous lengths of material with a constant cross-sectional shape. Traditional methods of extrusion will not produce a continuous length of material having discontinuities in the cross section or a non-uniform cross section along its length. Co-extrusion takes place when multiple extrusions of two or more materials are combined.

Blow molding occurs when a measured amount of polymer is extruded to form a tube shape. Before the tube extrusion cools, the tube extrusion is placed in a two-piece mold having the desired shape. Air is blown under pressure into the extrusion forcing the tube walls to conform to the contours of the mold.

Casting occurs when polymeric material is poured into a mold and allowed to solidify. For thermoplastics, solidification occurs upon cooling from the molten state.

A wide variety of automotive components are formed from plastic polymer material. One specific example of such a component is a seal capable of direct attachment to a structure, such as a door seal capable of direct attachment to a vehicle body or vehicle door. Door seals may be installed using fasteners or stapling operations. However, installation requires the step of retaining the seal against the structure while numerous fasteners are inserted. Use of fasteners adds handling cost, additional parts, and additional part numbers to the assembly process. Another attachment method involves the use of a seal in combination with adhesive between the seal and the vehicle frame or door frame. This method requires surface treatment of the vehicle frame or door frame before the adhesive can be applied, an undesirable step in the assembly process. Adhesives are available that do not require special surface treatment, but have increased expense. Another alternative, entails use of an extruded seal having a C-channel integrated into the extrusion. The C-channel is attached to the edge of the body sheet metal or to the edge of door panels. The C-channel seal is formed with a relatively complex extrusion. Due to the nature of the molten extrusion process and retention of the shape as the extrusion is cooled, concerns with dimensional repeatability from one component to another persist, this can affect its attachment to the vehicle body or door frame or increase in part rejection. Still, this design has been accepted due to the ease of assembly that it provides. Alternative designs have been unavailable due, in part, to the limitations of known forming techniques for such components.

The invention described herein overcomes the problems in forming a plastic component having a generally complex cross section along its length and provides, by way of example, a process for producing an improved door seal for a vehicle door. The process is suitable for wide application in forming plastic components having a complex cross section and for doing so in a commercially desirable manner.

### SUMMARY OF INVENTION

This invention relates generally to a process and apparatus for forming a component including thermoplastic material, and the component produced thereby. More specifically, the process and apparatus utilize an extrusion and zone molding process in which a polymeric material is extruded, shaped and cooled to form a primary extrusion having a shaped length of uniform cross section, zone heating is then applied to only a portion of the primary extrusion creating a molten zone in that portion, the molten zone is aligned with a section mold to mold only that portion of the primary extrusion. The portion section molded cools quickly forming a section molded portion. The process forms components in a reduced amount of time. The process can be quickly adapted to design changes and requires little in the way of equipment maintenance. Although an exemplary polymeric components are described herein, a variety of other components may be produced utilizing the apparatus and method described herein by varying the shape of either the primary extrusion component or the section molded component, or both.

According to one embodiment, each step occurs in-line, resulting in a continuous process capable of more efficiently producing components than would be accomplished by stretch-forming, injection molding or compression molding of the entire article. According to one embodiment, the primary extrusion is advanced inline so that a plurality of positions on the continuous extrusion can be sequentially zone heated and molded. In an alternative embodiment, a plurality of positions on the continuous extrusion are zone heated to create a plurality of molten zones and the plurality of molten zones are simultaneously molded.

The resulting components are produced at a higher rate, at lower cost and have improved dimensional uniformity from piece to piece. Other aspects of the present invention are provided with reference to the figures and detailed description of embodiments provided herein.

### BRIEF DESCRIPTION OF DRAWINGS

FIG. 1 is an isometric view of an exemplary plastic component;

FIG. 2 is an isometric view of an embodiment of a section mold unit;

FIG. 3A is a cross sectional view of a section mold operation;

FIG. 3B is a cross sectional view of a section mold operation;

FIG. 3C is a cross sectional view of a section mold operation;

FIG. 4 is a side view of an exemplary plastic component;

FIG. 5 is a bottom view of an exemplary plastic component formed with the described process;

FIG. 6 is an illustration of a section molding operation;

FIG. 7 is an embodiment of the process of the present invention;

FIG. 8 is a schematic representation of an in-line manufacturing process of the present invention;

FIG. 9 is a top view of a portion of a primary extrusion;

FIG. 10 is an isometric view of a section mold unit;

FIG. 11 is a side view of a section mold operation;

FIG. 12A is a cross-sectional view of an exemplary plastic component;

FIG. 12B is a side view of an exemplary plastic component;

FIG. 12C is a cross-sectional view of an exemplary plastic component;

FIG. 13 is a cross-sectional view of an exemplary plastic component;

FIG. 14 is a cross-sectional view of an exemplary plastic component;

FIG. 15A is a cross-sectional view of an exemplary plastic component;

FIG. 15B is a top view of an exemplary plastic component; and

FIG. 15C is an isometric view of an exemplary plastic component.

### DETAILED DESCRIPTION

It is desirable to develop a process for forming a plastic polymeric component having a complex cross section suitable for attachment to structure such as a vehicle body. A variety of devices and process were experimented with in an effort to form such a component. One novel process was successful. An exemplary component resulting from this process is shown in FIG. 1. The process used to form the component, provides short cycle time, can be quickly adapted to design changes, and is entirely automated.

FIG. 1 illustrates an embodiment of an exemplary polymeric component 1 formed into a polymeric door seal having a primary extrusion 10 formed into the shape of an elongated seal and section molded portion 20 formed into the shape of a barbed snap. The primary extrusion 10 may be formed into any of a variety of cross sections. The section mold feature has variable wall thickness, variable outer diameter and variable cross sectional shape. The section molded portion 20 is formed after the primary extrusion 10 by zone heating a portion of the primary extrusion 10 to create a molten zone within the primary extrusion 10. The section molded portion 20 is then compressed into a die cavity until the section molded portion 20 takes the shape of the die cavity and forms a solid state while remaining integral to the primary extrusion 10. The process for manufacturing the exemplary component provides components that are dimensionally uniform and which have a cross-section more complex than attained with plastic drawing techniques. The process also provides a shorter cycle time than compression molding and injection molding techniques, and is less complex in nature than vacuum molding or blow molding techniques. The process eliminates material waste associated with trimming operations.

The section molded portion 20 maybe formed to be more or less rigid than the primary extrusion 10. In the exemplary polymeric component 1, the section molded portion 20 extending from the primary extrusion 10 is more rigid in order to serve as a fastener providing secure attachment of the primary extrusion to a mating structure 50 such as the vehicle frame or vehicle door panel. As shown in FIG. 1, the section molded feature 20 is capable of interconnection with an aperture 52 in the mating structure 50 and has sufficient rigidity to retain the primary extrusion 10 relative to the mating structure 50.

Although an exemplary polymeric component 1 in the form of a polymeric door seal having a primary extrusion 10 in the form of an elongated seal and a section molded portion 20 in the form of a barbed snap are discussed, a wide variety of components may be produced with the apparatus and method described herein by varying the shape of either the primary extrusion component 10 or the section molded component 20, or both.

FIG. 10 is a view of a zone heating unit 300 heating a portion of a primary extrusion 10 to form a molten zone 35 in that portion, leaving at least a portion of the surrounding primary extrusion 10 in the solid state. Here, a primary extrusion 10 is fed into a zone heating unit 300. Zone heating unit 300 includes at least one zone heating element 310. In this embodiment, opposing zone heating elements 310 are aligned proximal upper 15 and lower 16 surfaces of the primary extrusion 10. The zone heating unit 300 may include heat elements 310 of a variety of types. In this embodiment, zone heating elements 310 are solid metal elements heated to about 700 degrees Fahrenheit. Heating elements 310 are placed proximal the upper and lower surfaces of the primary extrusion 10 at any suitable distance, but do not touch either surface. In one embodiment, heating elements 310 are placed as close in distance to the primary extrusion 10 as tolerances will allow without contacting the primary extrusion 10. In another embodiment, conductive heating elements 310 are placed directly in contact with the plurality of surfaces 15, 16 of the primary extrusion 10. In addition, other forms of heating elements 310 may be used and are contemplated within the scope of the invention including without limitation, convection heating units that direct heated air over the primary extrusion, infrared heating units, and induction heating heating units.

Once a molten zone 35 is formed between the heating elements 310, the primary extrusion is advanced and an additional portion of the primary extrusion 10 heated to repeat the process. In an alternative embodiment, heating elements may be provided in more than one location along the length of the primary extrusion 10 to simultaneously heat more than one portion of the primary extrusion, simultaneously forming more than one molten zone 35, while leaving surrounding portions of the primary extrusion 10 in the solid state.

FIG. 11 is a side view of a zone heating unit 300 incorporating an aligning mechanism 320 for accurately aligning the primary extrusion 10 relative to the zone heating elements 310. In this embodiment heating elements 310 are aligned proximal a plurality of surfaces 15, 16 of the primary extrusion 10, but do not contact the surfaces 15, 16. Molten zone 35 is formed between the heating elements 310. In this embodiment, the aligning mechanism is in the form of upper surface guide 325 and lower surface guide 326. Each surface guide includes an aperture 327 and 328 to provide for positioning of the heating elements 310 in close proximity to the upper and lower surfaces 15, 16 of the primary extrusion 10. Lower surface guide 326 and upper surface guide 325 provide sufficient clearance for the primary extrusion to pass between while maintaining tight tolerance between the surfaces of the primary extrusion 10 and each heating element 310. Although an aligning mechanism 320 in the form of a surface guide is discussed, other alignment mechanisms are contemplated and within the scope of the invention including without limitation channel guides, roller guides or other form of guide to accurately position the primary extrusion 10 relative to zone heating elements 310.

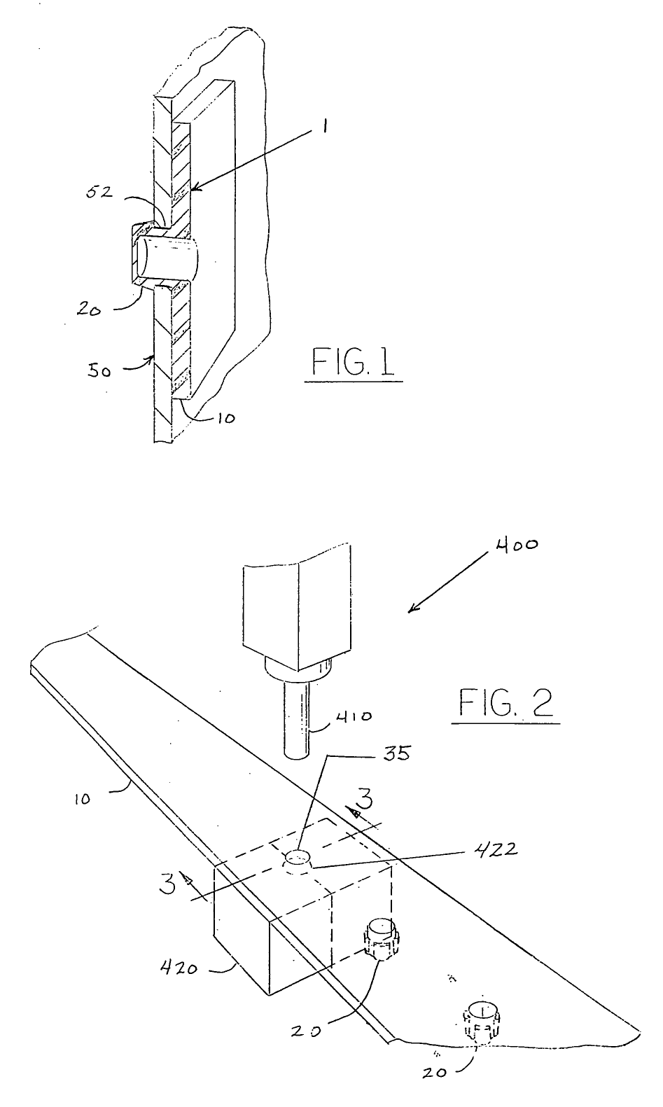

FIG. 2 is a view of a section mold unit 400 having a pressing unit 410 and a die 420 having a die cavity 422. In this embodiment, the die 420 is held in a stationary position. A portion of the primary extrusion 10 includes a molten zone 35. Once the portion of the primary extrusion 10 having the molten zone 35 is aligned over the die cavity 422, the pressing unit 410 is actuated to exert a downward force on the material in the molten zone 35 pressing the viscous material into the cavity 422. The viscous material associated with the molten zone 35 flows sufficiently to fill the cavity 422.

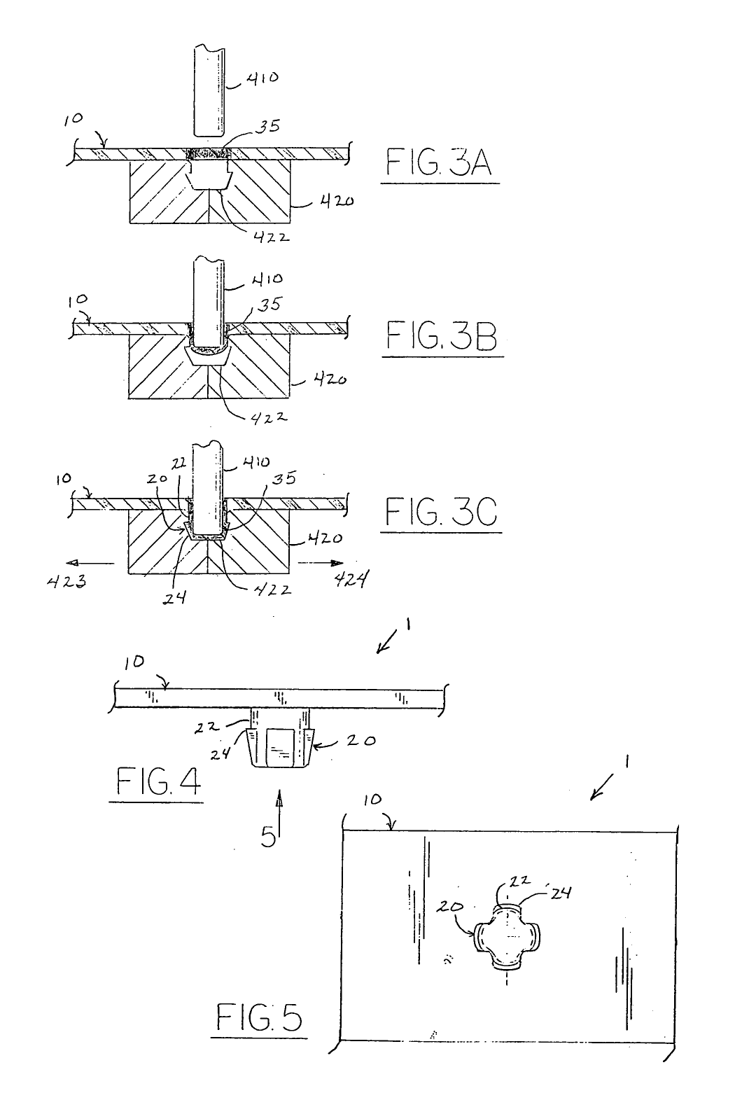

FIG. 3A is a cross sectional view of an embodiment of a section mold operation. As described in reference to FIG. 3, the portion of the primary extrusion 10 aligned over the cavity 422 forms a molten zone 35, while the surrounding portion of the primary extrusion 10 is in a solid state. Pressing unit 410, provided in the form of a mandrel, is positioned over the cavity 422. The die 420 is provided as a split die.

FIG. 3B is a cross sectional view in which the pressing unit 410 begins to compress the portion of the primary extrusion 10 having a molten zone 35. Here, the portion of the primary extrusion 10 having the molten zone 35 begins to take the shape of the die cavity 422 while remaining integral to the primary extrusion 10.

FIG. 3C is a cross sectional view in which the pressing unit 422 is in a fully extended position and has fully compressed the portion of the primary extrusion 10 having the molten zone 35. The primary extrusion 10 material completely fills the mold cavity 422 and conforms to the shape of the pressing unit 410 and the die cavity 422, while remaining integral to the primary extrusion 10. The material in the mold cavity 422 quickly becomes solid state. According to one embodiment, the pressing unit 410 and die 420 are at a lower temperature than the molten zone 35 being pressed. This aids in cooling the section molded portion 20 at a higher rate. In another embodiment, the pressing unit 410 is about the same temperature as the molten zone. This can aid in flow within the die cavity 420 and reduce part wear. In yet another embodiment, the pressing unit 410 is at a temperature greater than the molten zone 35. The section mold feature has variable wall thickness, variable outer diameter and variable cross sectional shape. The section molded feature 20 in this embodiment has an initially thin walled portion 22, and a thicker walled portion 24 with angular projections forming a barbed snap feature. The die 420 of this embodiment is a split die. The split die 422 is parted in the direction of arrows 423 and 424, releasing the exemplary plastic component 1. The result is a primary extrusion 10 with an integral section molded portion 20 having a dimensionally repeatable shape with a cross-section more complex than attained with plastic drawing techniques, and capable of formation faster than compression mold, vacuum mold, or injection mold techniques.

FIG. 4 is a side view of an exemplary plastic component 1 after removal from the section mold unit 400 of FIG. 2. The exemplary plastic component 1 includes a primary extrusion 10 in the form of an elongated extrusion and a section molded portion 20 in the form of an integral barbed snap having an initially thin walled portion 22 and thicker walled portion 24 with angular projections 26.

FIG. 5 is a bottom view of an exemplary polymeric component 1 formed with the described process. The exemplary plastic component 1 includes a primary extrusion 10 in the form of an elongated extrusion and a section molded portion 20 in the form of an integral barbed snap having an initially thin walled portion 22 and thicker walled portion 24 with angular projections 26.

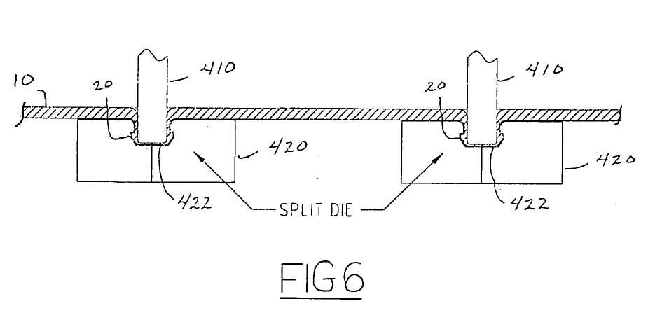

FIG. 6 is an illustration of an alternative embodiment of a section molding operation. In this embodiment, the section mold 400 includes a plurality of pressing units 410 and a plurality of dies 420. A primary extrusion 10 is simultaneously zone heated along a plurality of positions along its length, providing a plurality of molten zones 35. A plurality of section molded portions 20 are formed simultaneously according to this embodiment.

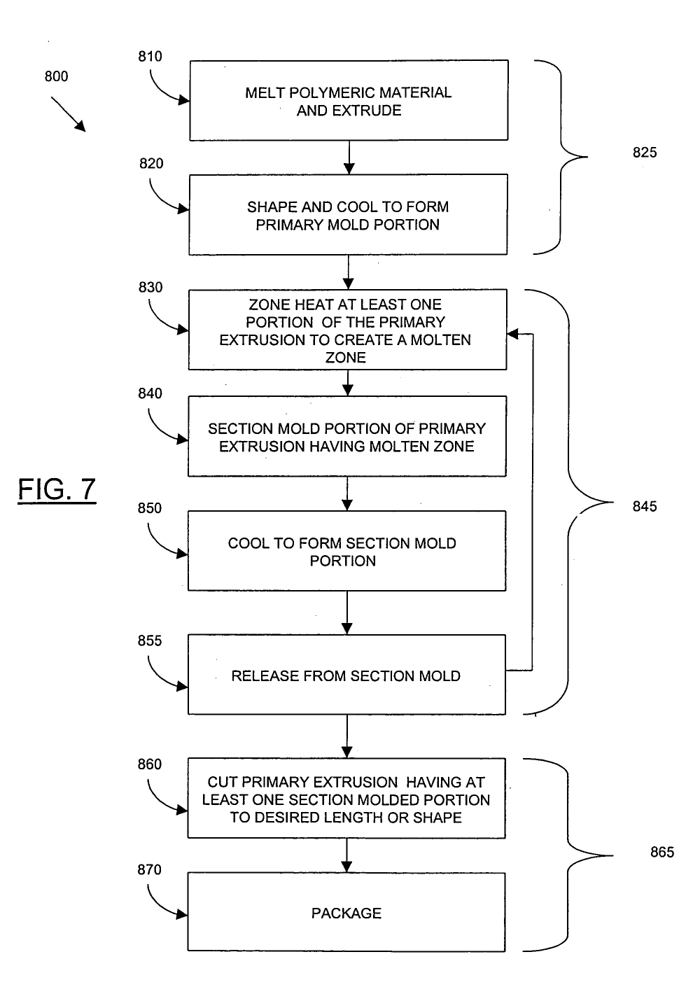

FIG. 7 is an embodiment of the process of the present invention 800. The primary extrusion process 825 includes extrusion of a molten remeltable polymer 810. The extruded polymer is then shaped and cooled 820 to form the primary extrusion 10. The section molded process 845 includes zone heating of at least one portion of the primary extrusion to create a molten zone 830, leaving the surrounding portions in a solid state. Then section molding the portion having the molten zone 840 and cooling the section molded portion 850 as described herein to form the section molded portion 20. The section molded portion 20 is then released from the section mold unit 855. The packaging process 865 includes cutting the polymeric component to the desired length 860 to form the exemplary component 1, described herein, and dropping the exemplary component 1 directly into a package 870 for shipping. According to one embodiment, the steps described in process 800 occur in-line. In another embodiment, the primary extrusion 10 having at least one section molded portion 20 can be cut to a desired shape.

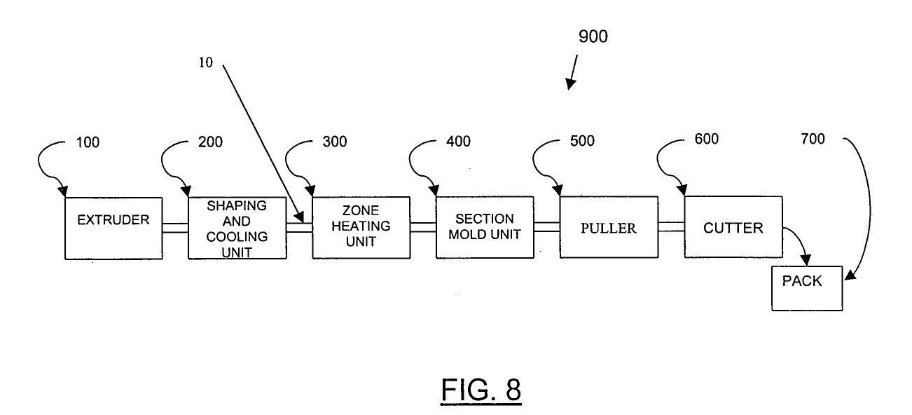

FIG. 8A is a schematic representation of an embodiment of an apparatus 900 that performs the process of the present invention 800 in-line. The apparatus 900 forms the exemplary component 1 described herein with lower cycle time than can be accomplished with other methods. An extruder 100 is utilized to melt polymeric material and force the material through an orifice. Extruders 100 typically utilize a screw mechanism to place the molten material under pressure. The pressure forces the molten material through an orifice at the exit of the extruder 100. The shape of the orifice can establish the shape of the extrusion. The extrusion directly enters the shaping and cooling unit 200 to form the primary extrusion 10. The cooled primary extrusion 10 exits directly to the zone heat unit 300. The zone heat unit 300 is utilized to zone heat at least one portion of the primary extrusion 10 to form a molten zone 35 therein, leaving the surrounding portions in a solid state. The in-line process of this embodiment, does not require a conveyer to carry the primary extrusion 10. Instead, a puller 500 acts on a portion of the primary extrusion 10 to pull the continuous primary extrusion 10 through the zone heat unit 300 as it exits the cooling and shaping unit and then on to the section mold unit 400 as it exits the zone heating unit 300. Pullers are generally known in the art and typically include an upper re-circulating track and a lower re-circulating track that pull an extrusion through frictional contact between surfaces of the tracks and the extrusion. According to this embodiment, the primary extrusion 10 is processed in one continuous piece from the initial extrusion form exiting the extruder 100, through the shaping and cooling unit 200, through the zone heating unit 300, through the section mold unit 400, through the puller 500, until reaching the cutter 600 where it is cut to form the final component. The puller in this embodiment utilizes a soft foam belt that conforms to some degree around the section molded portion 20. The arrangement of the extruder 100, cooling unit 200, zone heating unit 300, section mold unit 400, puller 500, and cutter 600 eliminates the need for a conveyer and reduces cycle time by providing direct feed from one unit to another.

The shape of the extruder 100 exit orifice can take any one of a variety of shapes including without limitation, rectangular, C-shaped, tubular, rounded aperture, square aperture, or any combination thereof. The shaping and cooling unit 200 may utilize a variety of cooling methods including without limitation, air cooling, water spray, submersion. The zone heating unit 300 may include heat elements of a variety of types. Heat elements may be located proximal one surface or proximal a plurality of surfaces of the primary extrusion. Alternatively, heat elements may be placed in direct contact with one or more surfaces of the primary extrusion 10. The zone heating unit 300 may utilize any of a variety of types of heat sources, including without limitation, radiant heating, conductive heating, convection heating, infrared heating, and induction heating. According to the invention, an alignment mechanism in the form of surface guides, channel guides or any other form of guide may be used to accurately position the primary extrusion 10 relative to zone heating elements. The section mold unit 400 applies a compression force for pressing the molten zone 35 into the die cavity 422 and applies a retraction force for removing the pressing unit 410. The section mold unit 400 utilizes a pressing unit 410 that can be interchanged with a pressing unit 410 having a different dimension and shape, and utilizes a die unit 420 that can be interchanged with a die comprised of a single piece die, split piece die or other formation. The cutting unit 600 includes a cutter that cuts the final extrusion to any desired length. In an alternative embodiment, the cutter 600 includes a shaped cutting unit that cuts the primary extrusion 10 having at least one section molded portion 20 to any desired shape, including without limitation round, square, or rectangular shapes.

To form exemplary component 1, thermoplastic polymer pellets are fed into the extruder 100. Initially, molten material from the extruder may be cooled in the cooling unit without sizing blocks, the initial extrusion exits the cooling unit, and is fed into the puller. Once engaged with the puller, additional shaping in the cooling unit is accomplished by setting split sizing blocks around the extrusion. The extruder 100 continues to melt pellets and extrude the material through a an exit orifice. In this embodiment a rectangular horizontally elongated exit orifice is used to form an initial extrusion having a thickness of about 2 mm. The cooling unit is a water submersion tank with a series of block forms about 1 inch wide having a central rectangular sizing aperture corresponding to the final desired shape of the extrusion exiting the exit orifice. The block forms help to support the extrusion and retain its shape during cooling. A primary extrusion having a thickness of about 2 mm exits the shaping and cooling unit. The puller 500 acts at a constant intermittent speed on the 2 mm thick extrusion to pull the extrusion through the zone heat unit 300, through the section mold unit 400, through the puller 500 and out to the cutter 600. The zone heat unit 300 includes surface guides for accurately positioning the extrusion relative zone heating elements 310 having solid metal heating elements. The zone-heating unit 300 includes upper and lower zone heat elements 310, each set to about 700 degrees Fahrenheit. Heating elements are each positioned close to the primary extrusion 10, but not in contact with, the upper and lower surface of the primary extrusion 10 for about 4 seconds to heat a portion of the primary extrusion 10 to its molten state. The section mold unit 400 actuates to press a pressing unit 410 in the form of a mandrel into at least one portion of the primary extrusion 10 having a molten zone, pressing the material into the die cavity 422 and retracting with a cycle time of about 1 second. The primary extrusion 10 with section molded portions 20 is then cut to the desired length of several feet and is dropped into a package. The process according to this embodiment is fully automated. In an alternative embodiment, the line is arranged as described, except that an increased line speed is achieved by locating a series of opposing zone heat elements within the zone heating unit along the path of travel of the primary extrusion 10, collectively heating one portion of the primary extrusion 10 to create a molten zone. For example, a plurality of heat elements would be stationed to heat a given portion of the primary extrusion for a time in the range of about 1 second each, to allow the primary extrusion 10 to advance to match a 1 second cycle time of the section mold unit 400. In this manner, the cycle time is not limited by the time for one set of heat elements to heat one portion of the primary extrusion 10. Heating units 300 utilizing heating elements set to a higher temperature or using other methods of heating may be used to further reduce cycle time.

In an alternative embodiment, the section molded portion 20 is formed off line from the formation of the primary extrusion 10. A primary extrusion is provided, and is fed into a zone heating unit 300. While FIG. 8 relates to a continuous inline process for forming both the primary extrusion 10 and the section molded portion 20 inline, an off line process is also contemplated and within the scope of the invention.

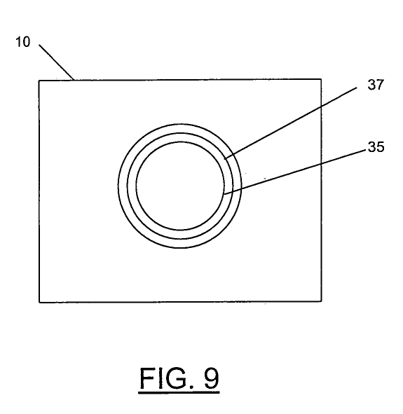

FIG. 9 illustrates the portion of the primary extrusion 10 having the molten zone 35, in more detail. Thermal gradients 37 extend through the adjacent material aiding in the transition between the primary extrusion 10 and the integral section mold 20. The primary extrusion being heated, may be formed from a single extrusion or may be a co-extruded piece.

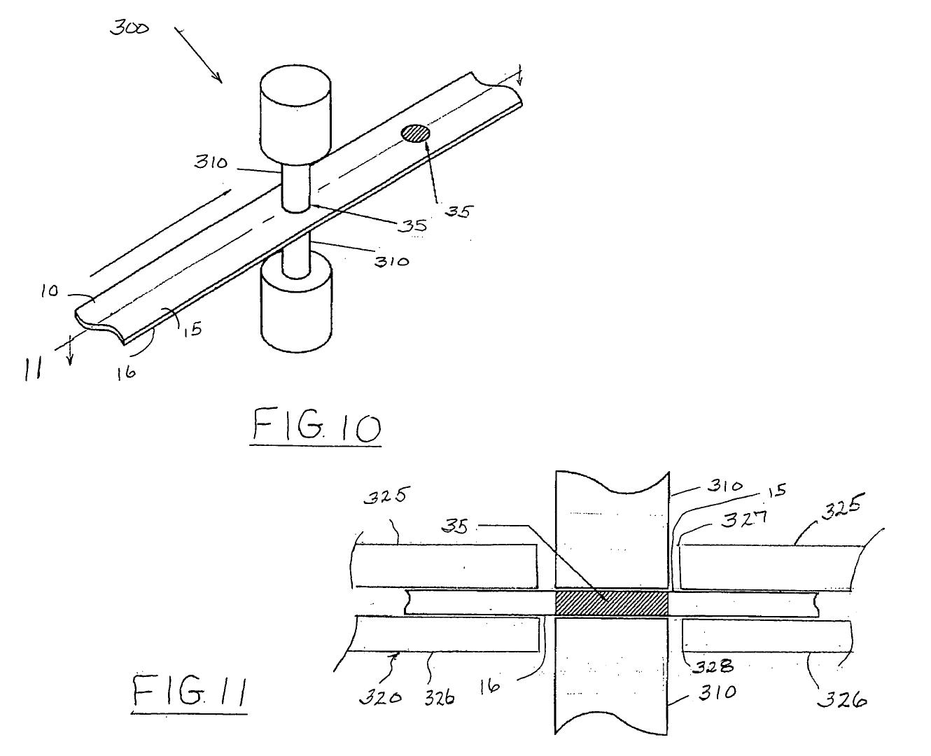

FIG. 12A is a cross-sectional view of an exemplary polymer component 2 having a primary extrusion 10 having a crescent shaped co-extruded cross-section 11 in which the curved portion 42 of the primary extrusion 10 is formed from a polymer different from the polymer used to form the base portion 44, the separate extrusions are fed through a single die where they are co-extruded to form a single part, then shaped and cooled in a conventional manner. Both polymers need not be thermoplastic as thermoplastic material can be co-extruded with non-thermoplastic material. In one embodiment, both portions of the extrusion are formed from thermoplastic materials. The curved portion of the extrusion is formed from a thermoplastic elastomer, and the straight portion of the extrusion is formed from talc-filled polypropylene. In another embodiment, a thermoplastic material is co-extruded with a non-thermoplastic material to form a primary extrusion 10. The curved portion of the extrusion is formed from a non-thermoplastic polymer, and the straight portion of the extrusion is formed from polypropylene. In one embodiment, section molded portions 20 are formed into corrugated fasteners 52 and tabbed fasteners 53 along the base portion 44 according to the process described herein. Accordingly, at least one section molded portion 20 in exemplary component 2 differs in shape from at least one other section molded portion. More specifically, some section molded portions 20, form corrugated fasteners 52 having angled corrugations 54 utilizing a pressing unit 410 in the form of a mandrel having a corrugated shape and a die cavity 422 having a corrugated shape corresponding to the shape of the mandrel. Other section molded portions 20, form tabbed fasteners 53 with tabs 55 projecting outwards utilizing a split die cavity 422 having a shape corresponding to a tab. FIG. 12B is a side view of the exemplary polymer component 2 with a plurality of evenly spaced section molded portions 20, 21. FIG. 12C is a cross sectional view showing section molded portion 20 formed into tabbed fasteners 53 with tabs 55.

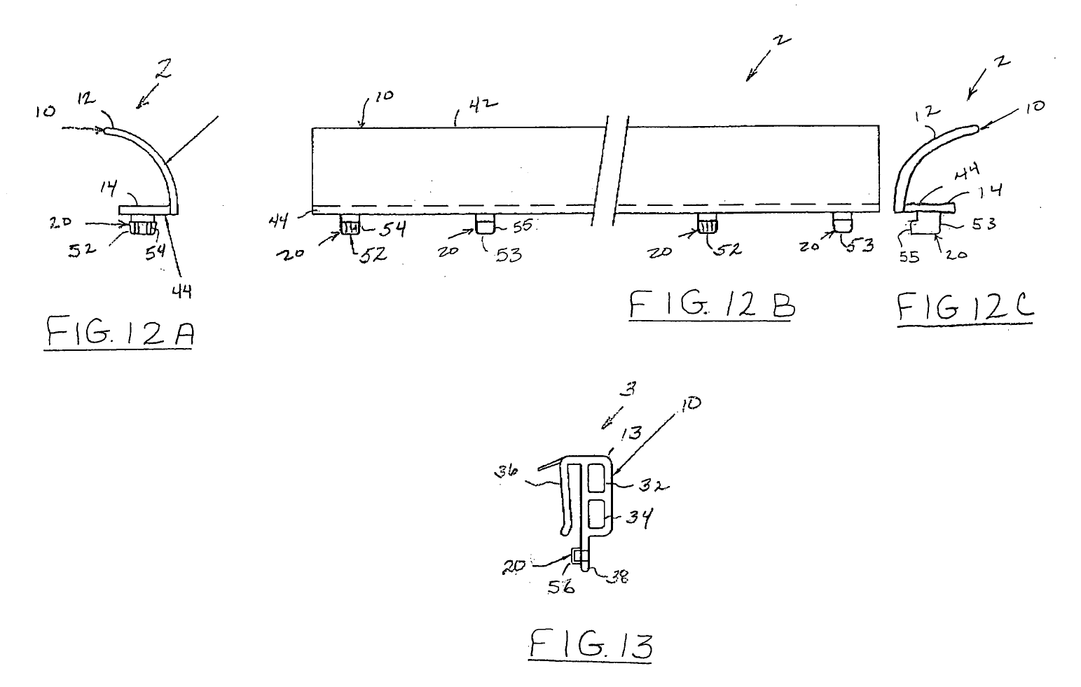

FIG. 13 is a cross-sectional view of an exemplary polymer component 3 having a primary extrusion 10 having a co-extruded cross-section 13 in the form of a set of channels 32 and 34 as well as clip feature 36 formed of a polymer different than the polymer of the extension 38. At least one section molded portion 20 is formed along the length of extension 38. In this embodiment, section molded portion 20 is formed in the shape of a projection 56 for positioning the extrusion during assembly, but does not act as a fastener. In one embodiment, thermoplastic elastomer material of a certain durometer forms channels 32 and 34 and clip feature 36 and is co-extruded with polyproylene material to form extension portion 38. In another embodiment, non-thermoplastic material forming channels 32 and 34 and clip feature 36 is co-extruded with thermoplastic material forming extension portion 38.

FIG. 14 is a cross sectional view of a section mold feature 20. According to this embodiment, the primary extrusion 10 and section-molded portion 20 are formed of a thermoplastic material such as 20% talc-filled polypropylene, a low cost thermoplastic common in automotive components. The primary extrusion is formed to have a 2 mm thickness 28. From that, a barbed snap having a 0.6 cm inner diameter, a 05 cm thin walled 22 portion, and a 0.1 cm thick walled 24 portion and a 0.85 cm inner length 26 is formed by applying an insertion force of about 5.5 lb and an extraction force of about 23 lb.

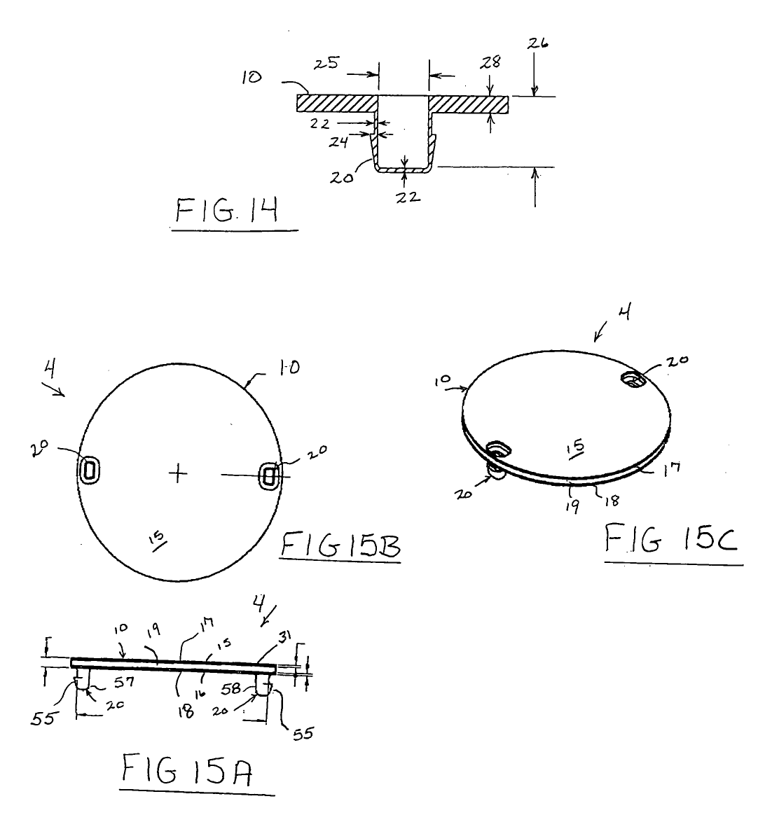

FIG. 15A is a side view of an exemplary component 4, in which the co-extruded cross-section 31 is formed of a layered co-extrusion. According to this embodiment, one polymer is extruded to form upper 17 and lower 18 layers while a different polymer is extruded to form central layer 19 to form a primary extrusion 10 in the form of a co-extruded layered sheet. The co-extruded sheet has upper surface 15, and lower surface 16. The co-extruded sheet is zone heated, and section molded as described herein. A cutting unit with a circular cutter is used to cut the primary extrusion 10 having section molded portions 20 into circular exemplary component 4. Exemplary component 4 is then dropped into a package for shipping. Exemplary plug component 4, includes section molded portions 20 in the form of opposing tab fasteners 57, 58 with tab portions 55 extending outward from one another. Opposing tab fasteners 57, 58 act against the edge of an aperture in the mating structure, creating a retentive fit within the aperture. In an alternative embodiment, opposing tabs 57, 58 may snap into individual apertures corresponding to each tab to create a retentive fit. In this embodiment, section molded portions 20 are formed into tabs 57, 58 utilizing pressing units 410 in the form of substantially rectangular mandrels, and dies 420 having split die cavities 422 corresponding to a tab shape. FIG. 15B is a top view of exemplary component 4 having upper surface 15, and primary extrusion 10 having section molded portions 20 cut into a circular component. FIG. 15C is an isometric view of exemplary component 4 showing primary extrusion portion 10 with section molded portions 20 cut into a circular component. In one embodiment, the primary extrusion is formed with a thermoplastic elastomer of a certain durometer co-extruded with talc-filled polypropylene to form a co-extruded sheet having upper and lower layers formed of thermoplastic elastomer and a center layer of talc-filled polypropylene.

Although an exemplary polymeric components are described herein, a variety of other components may be produced utilizing the apparatus and method described herein by varying the shape of either the primary extrusion component or the section molded component, or both. Such components may include without limitation, wire harness organizers with integral fasteners, and trim hole plugs with integral fasteners.

It is contemplated that the present invention include use of a primary extrusion 10 having at least a portion formed of a thermoplastic material including without limitation: polyethylene, soft or rigid TPE, nylon, ABS/PVC. As used herein, molten refers to the heated state at which the thermoplastic is sufficiently viscoelastic to flow into the die cavity 422 under pressure from the pressing unit 410 into the desired final shape. The primary extrusion 10, may be extruded of a single thermoplastic material or co-extruded with other thermoplastic or non-thermoplastic material. In an alternative embodiment, the primary extrusion 10 may be replaced by a primary plastic component formed by other methods, including without limitation compression molding, injection molding, blow molding, casting. The section mold operation may then be utilized on such a piece to form a section mold portion 20 in that piece.

The process used to form the exemplary components of the present invention, provides short cycle time, can be quickly adapted to design changes, and can be entirely automated.

While the present invention has been described with reference to an exemplary component, a variety of components may be produced utilizing the apparatus and process described herein. Modifications and variations in the invention will be apparent to those skilled in the art in light of the foregoing description. It is therefore contemplated that the appended claims and their equivalents will embrace any such alternatives, modifications and variations as falling within the scope of the present invention.

What is claimed is:

1. A method of forming a polymeric component, comprising:
providing a primary extrusion in a solid state;
zone heating at least one portion of the primary extrusion to create a molten zone within the at least one portion, leaving surrounding portions of the primary extrusion in a solid state; and
compressing the at least one portion between a pressing unit and a die cavity until the at least one portion takes the shape of the pressing unit and die cavity and forms a solid state section molded feature integral with the primary extrusion.

2. The method of claim 1 the step of providing a primary extrusion, further comprising:
heating a polymeric compound and forcing the heated compound through an orifice to form a heated extrusion; and
cooling the heated extrusion to form a primary extrusion in a solid state.

3. The method of claim 1 further comprising:
aligning the zone heating and compression steps in an off-line operation; and
forming the section molded portion in the off-line operation.

4. The method of claim 2 further comprising:
aligning the heating, cooling, zone heating and compressing steps in an in-line operation; and
forming the polymeric component in the in-line operation.

5. The method of claim 1 the step of zone heating at least one portion, further comprising:
applying zone heating of the type selected from the group consisting of:
convection heating, radiant heating, conduction heating, infrared heating, and induction heating.

6. The method of claim 1 further comprising:
providing a section mold unit having at least one pressing unit and at least one die cavity for forming a section molded feature integral to the primary extrusion; and
aligning the at least one molten zone with a corresponding die cavity of the section mold in preparation of compressing the molten zone.

7. The method of claim 6, further comprising:
providing the die cavity to be comprised of a split die having a combined shape corresponding to the outer shape of a barbed projection to be section molded from the primary extrusion, and
providing the pressing unit to be comprised of an upper mandrel having a shape corresponding to the inner shape of the barbed projection; and
raising the mandrel and separating the split die to release the polymeric component.

8. The method of claim 1, further comprising:
clamping the solid state portion of the primary extrusion to stabilize the primary extrusion prior to compressing the molten zone.

9. The method of claim 1 the step of zone heating at least one portion, including:
simultaneously zone heating a plurality of portions along the length of the primary extrusion to simultaneously create a plurality of molten zones, leaving the surrounding portions of the primary extrusion in a solid state;
providing a section mold having a plurality of die cavities and pressing units; and
aligning each portion having a molten zone with a corresponding die cavity of the section mold.

10. The method of claim 6, further comprising:
providing a section mold unit having a plurality of identical die cavities and pressing units.

11. The method of claim 6, further comprising:
providing a section mold unit having a plurality of die cavities and pressing units and wherein at least one die cavity and pressing unit define a section mold feature shape different from at least one other die cavity and pressing unit.

12. The method of claim 1 the step of zone heating at least one portion, including:
zone heating a first portion of the primary extrusion to create a molten zone within the first portion, while leaving the remaining portion of the primary extrusion in a solid state;
providing a section mold having a die cavity and pressing unit, the die cavity and pressing unit;
aligning the molten zone of the first portion with the die cavity;
compressing the first portion between the pressing unit and die cavity until the first portion takes the shape defined by the die cavity and pressing unit and forms a solid state integral with the primary extrusion;
advancing the primary extrusion;
zone heating a second portion of the primary extrusion to create a molten zone within the second portion, leaving the surrounding portion of the primary extrusion in a solid state;
aligning the molten zone of the second portion with the die cavity; and
compressing the second portion between the pressing unit and the die cavity until the second portion takes the shape defined by the die cavity and pressing unit and forms a solid state integral with the primary extrusion.

13. A polymeric component, comprising:
a primary extrusion; and
a section molded portion integral with the primary extrusion, the section molded portion formed after the primary extrusion by zone heating a portion of the primary extrusion to create a molten zone and compressing the portion having the molten zone in a die cavity until the section molded portion takes the shape of the die cavity and forms a solid state.

14. The polymeric component of claim 13 further comprising:
the primary extrusion formed by heating a polymeric compound and forcing the heated compound through an orifice to form a heated extrusion; and
cooling the heated extrusion to form the primary extrusion in a solid state.

15. The polymeric component of claim 13 further comprising:
the section molded portion being compressed into the die cavity by a pressing unit having a corrugated shape and the die cavity having a shape corresponding to a corrugated shape.

16. The polymeric component of claim 13 further comprising:
the primary extrusion being formed at least in part by thermoplastic material selected from the group consisting of: polyethylene, soft or rigid TPE, nylon, ABS/PVC.

17. A polymeric component, comprising:
a primary extrusion of co-extruded material, wherein the primary extrusion includes at least one thermoplastic material; and
at least one section molded portion formed in the portion of the primary extrusion formed from thermoplastic material and extending from the primary extrusion and integral with the primary extrusion, the section molded portion capable of interconnection with an aperture in a portion of a mating structure and having suitable rigidity to retain the primary extrusion relative to the structure.

18. The polymeric component of claim 17 further comprising:
the section molded portion being in the shape of a barbed projection having a thin walled portion having a first outer diameter and extending from the primary extrusion and a thick walled portion having a second outer diameter greater than the first outer diameter.

19. The polymeric component of claim 17 further comprising:
the primary extrusion being formed from a layered co-extrusion, each layer formed of thermoplastic material.

20. The polymeric component of claim 17 further comprising:
the primary extrusion being formed from a C-shaped cross section in which a portion of the cross-section is formed from thermoplastic material.
